(19) United States
(12) Patent Application Publication
(10) Pub. No.: US 2018/0337494 A1
(43) Pub. Date: Nov. 22, 2018

(54) ELECTRIC POWER DISTRIBUTION MODULE AND SYSTEM

(71) Applicant: iCONN SYSTEMS, LLC, Lombard, IL (US)

(72) Inventors: Richard M. Regole, JR., Glen Ellyn, IL (US); Anthony S. Czyz, Schaumburg, IL (US); John P. Regole, Chicago, IL (US)

(21) Appl. No.: 15/980,426

(22) Filed: May 15, 2018

Related U.S. Application Data
(60) Provisional application No. 62/506,611, filed on May 16, 2017.

(51) Int. Cl. H01R 13/64; H01R 27/02; H01R 13/11; H01R 13/05

(52) U.S. Cl. CPC H01R 13/64; H01R 13/057; H01R 13/112; H01R 27/02

(57) ABSTRACT

Systems and devices for distributing electric power. An electrical power distribution module includes a housing enclosing an interconnection member, a first main connector formed in the housing having a first plurality of module contacts, a second main connector formed in the housing having a second plurality of module contacts. The first main connector and the second main connector may connect to electrical conductors to receive an electrical current from a power source. At least two conductive paths on the interconnection member connect to at least two of the first plurality of module contacts and to at least two of the second plurality of module contacts. At least one output port is formed in the housing with a pair of output port contacts connected to the at least two conductive paths connected to the module contacts.

### CROSS-REFERENCE TO RELATED APPLICATIONS

This application claims the benefit of U.S. Provisional Patent Application Ser. No. 62/506,611, “ELECTRIC POWER DISTRIBUTION MODULE AND SYSTEM,” filed May 16, 2017, the entire contents of which are hereby incorporated by reference.

### FIELD OF DISCLOSURE

The present subject matter relates to systems and apparatuses for distributing electric power, and more particularly, for distributing electric power from a single source to multiple remote locations.

### BACKGROUND

In some items, such as cabinets for use in, for example, kitchens or the like, or in furniture or other items there may be a need to provide electric power to one or more devices, such as lighting, located in the item. At times, the item containing the device(s) may be located remotely from a source of electric power. Thus, for example, a plurality of kitchen cabinets may be located near to or adjacent to one another and a driver circuit disposed in or adjacent one of the cabinets develops low voltage DC power from 110 volt AC utility power for LED lights and/or other low voltage electric loads in the cabinets. Some provision must be made in such an arrangement to deliver the low voltage power to the LED lights and/or other loads in the cabinets from the driver circuit.

In prior arrangements such as the foregoing, there was often a need to run separate wires between the driver circuit and the individual loads or groups of loads to prevent voltage drops occurring in one load or group of loads from adversely affecting the operation of other loads or load groups. Thus, the installer had to measure, cut, strip, mount, and interconnect multiple wires between the driver circuit and the loads, resulting in an unsightly and labor-intensive installation that was costly.

Kitchen and other cabinet manufacturers are currently looking to integrate low voltage wiring systems into their cabinets to facilitate LED lighting and other applicable low voltage power accessories. The intent is that the wiring or bussing system will be installed by the factory eliminating the need for custom installations by the consumer. However, two problems arise in such an arrangement. First, due to the geometry of standard cabinetry, the wiring system needs to be fitted with connectors within each cabinet and between adjacent cabinets after cabinet installation. Also, due to the nature of low voltage DC wiring, the voltage drop across long lines of wire needs to be minimized; otherwise, the LED drivers powering the lights cannot function. This places a limit on the overall length of the wiring system.

### SUMMARY

According to one aspect, an electric power distribution module comprises a housing enclosing an interconnection member, a first main connector formed in the housing having a first plurality of module contacts, and a second main connector formed in the housing having a second plurality of module contacts. The first main connector and the second main connector are configured to connect to electrical conductors to receive an electrical current from a power source. The interconnection member includes a plurality of conductive paths, where at least two conductive paths are in electrical connection with at least two of the first plurality of module contacts and at least two of the second plurality of module contacts. The electric power distribution module includes at least one output port comprising a pair of output port contacts electrically connected to the at least two conductive paths in electrical connection with the module contacts on the first main connector and the second main connector.

According to another aspect an electric power distribution system includes a driver circuit configured to provide a DC power, a first electric power distribution module, and a second electric power distribution module. The first electric power distribution module is configured to receive the DC power from the driver circuit. The first electric power distribution module includes a first main connector in electrical connection with a second main connector via a plurality of conductive paths between at least a pair of module contacts on the first main connector and at least a pair of module contacts on the second main connector. The first main connector and the second main connector are configured to connect electrically to either the driver circuit or a second electric power distribution module. The first electric power distribution module further includes at least one output port on the first electric power distribution module electrically connected with one of the at least one pair of conductive paths between the first main connector and the second main connector to provide power to a load in electrical connection with the at least one output port.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a block diagram of an electric power distribution system incorporating modules as disclosed herein.

FIG. 2 is an isometric view of a specific embodiment of an electric power distribution module usable in the system of FIG. 1.

FIG. 3 is a front elevational view of the housing of the module of FIG. 2.

FIG. 4 is an elevational view of a first side of the housing of FIG. 3 illustrating a first main connector.

FIG. 5 is an elevational view of a second side of the housing of FIG. 3 opposite the first side and illustrating a second main connector.

FIG. 6 is a bottom elevational view of the housing of FIG. 3 illustrating at least one input port and at least one output port.

FIG. 7A is a partial, left-side isometric view from above illustrating the housing with a front cover removed to illustrate components disposed therein.

FIG. 7B is a right-side isometric view from above illustrating the housing with the front cover removed to illustrate components disposed therein.

FIG. 7C is a left-side isometric view from below illustrating input and output ports.

FIG. 7D is a right-side isometric view from below illustrating input and output ports.

FIG. 7E is a front elevational view of the housing with the front cover removed to illustrate components disposed therein.

FIG. 8 is a front elevational view of a first face of the interconnection member of FIGS. 7A and 7B.

FIG. 9 is a back elevational view of a second face opposite the first face of the interconnection member of FIGS. 7A and 7B.

FIG. 10 is an elevational view of a conductor cable that may be used in the system of FIG. 1.

FIG. 11 is an isometric view of one of the male contacts used in the first main connector.

FIG. 12 is an isometric view of one of the female contacts used in the second main connector.

FIG. 13 is an elevational view of the male and female contacts of FIGS. 11 and 12 when mated.

FIG. 14 is an isometric view of a socket contact used in a female end of the conductor cable.

FIG. 15 is an isometric view of a prong contact used in a male end of the conductor cable.

### DETAILED DESCRIPTION

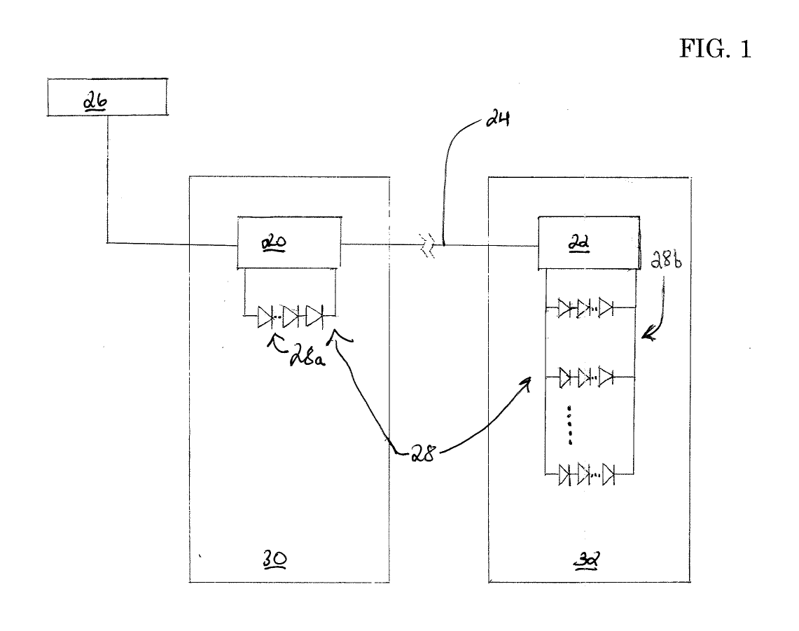

Referring first to FIG. 1, an electric power distribution system includes a first electric power distribution module 20, a second electric power distribution module 22 that is substantially or completely identical to the first module 20, and at least one conductor 24 extending between the modules 20, 22. A driver circuit may receive a main feed or main power line, which is typically an AC voltage signal. In the United States, the main power line in typical homes, offices, or other buildings is 110 volts AC. Other countries it may use as high as 240 volts AC. The driver circuit may convert the AC voltage to a DC power to drive LEDs or other DC powered devices. The driver circuit may convert the AC voltage (such as for example, a 110 volt AC utility power) into a low voltage electric power, such as 12 volt DC power (or another voltage, such as, for example, 5 volts, 24 volts, 36 volts, or any suitable voltage), which is supplied to at least one of the modules 20, 22 as described in greater detail hereinafter. One or more electric loads 28 are connected to one or both of the modules 20, 22 to receive power therefrom.

In a general sense, the modules may be located in different locations or at the same location and in or adjacent different items or structures or the same item or structure. Further, only one module, or more than two modules, may be utilized to distribute electric power developed by the driver circuit 26 and/or another source of power (not shown). In a specific embodiment, the first module 20 is disposed in a first cabinet 30, the second module 22 is disposed in a second cabinet 32, the loads 28 comprise first and second groups or strings 28a, 28b of LEDs, the driver circuit 26 is coupled to the first module 20, and power delivered to the first module 20 by the driver circuit 26 is transferred to the second module 22 by the conductor 24. The electric power delivered to the modules 20, 22 is, in turn transferred by the modules 20, 22 to the strings of LEDs 28a, 28b, respectively.

The module 20 will be described in detail as including elements identified by hyphenated reference numerals in conjunction with the main reference numeral 20, it being understood that the module 22 includes like elements. Because the modules 20, 22 are substantially identical to one another only the module 20 will be described herein.

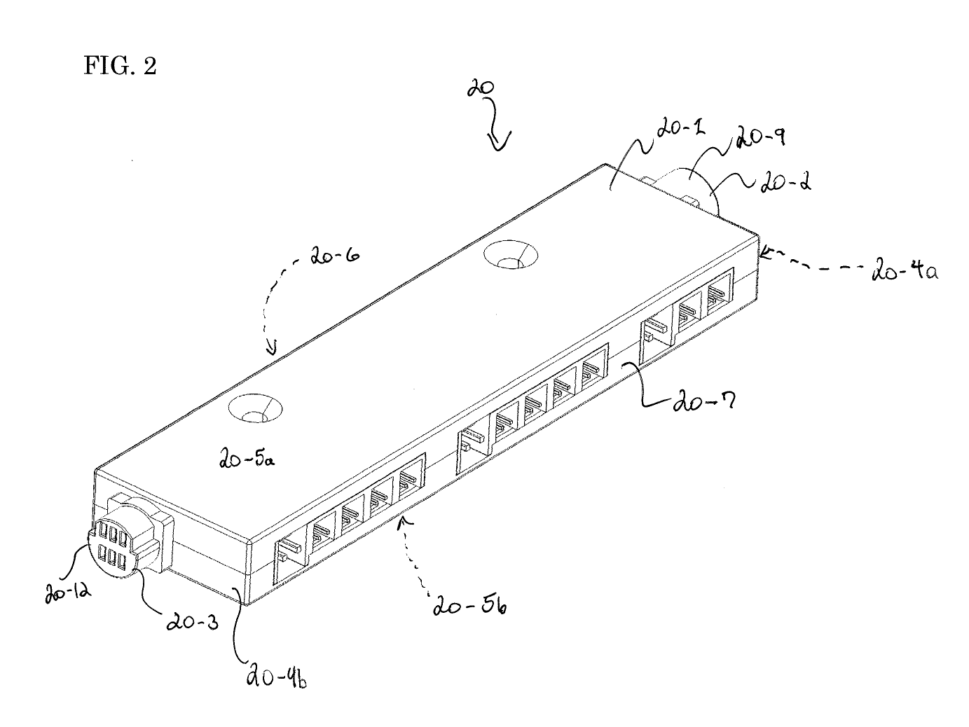

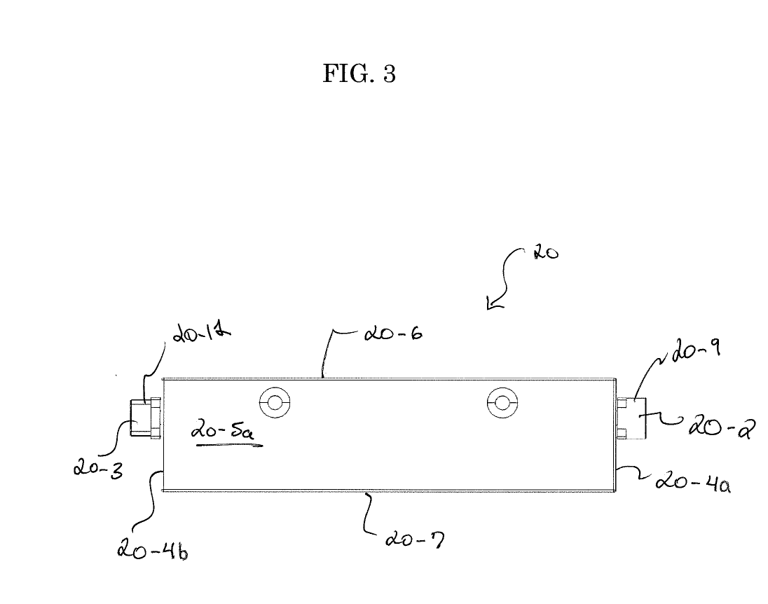

As illustrated in FIGS. 2-7E, the module 20 comprises a housing 20-1 that includes first (i.e., male) and second (i.e., female) main ports or connectors 20-2 and 20-3 disposed on opposed first (or right) and second (or left) sides 20-4a and 20-4b, respectively, a front face 20-5a, a rear face 20-5b opposite the front face 20-5a, and opposed top and bottom sides 20-6, 20-7, respectively. The first main connector 20-2 and the second main connector 20-3 each include module contacts to provide an electrical connection with a complementary connector.

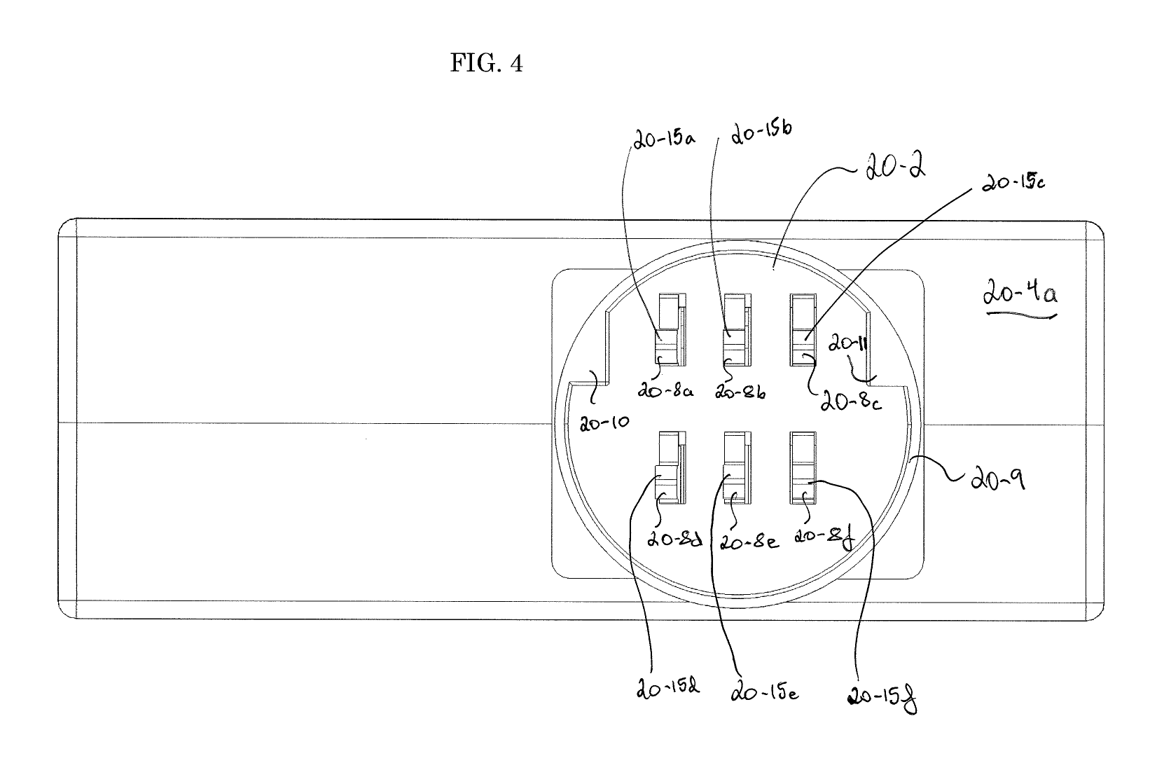

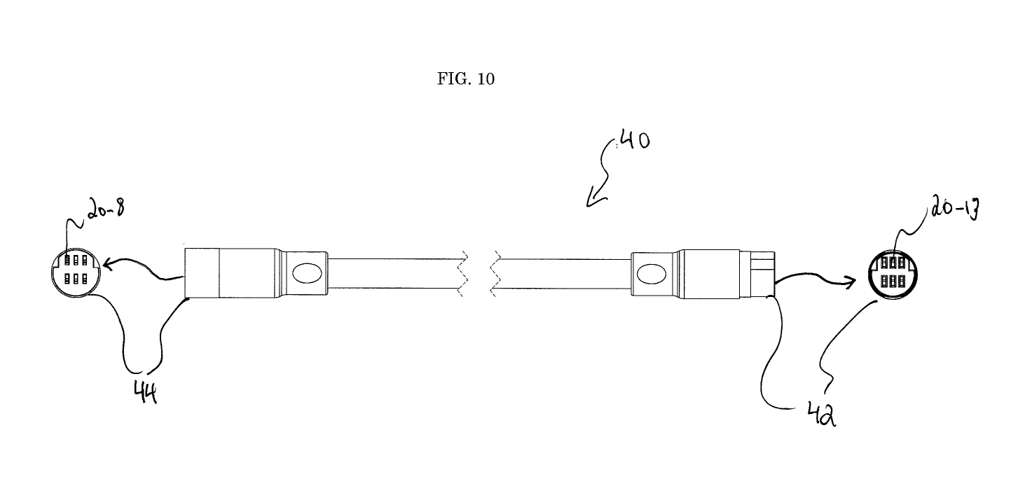

In an example implementation as shown in FIG. 4, the module contacts in the first main connector 20-2 include a plurality of male contacts 20-8 disposed in an array and surrounded by a collar 20-9. In the illustrated embodiment, six male contacts 20-8a through 20-8f are disposed in a regular array of two columns with three male contacts 20-8 in each column, although a different number of male contacts 20-8 may instead be provided in a different array and/or with regular or irregular spacing between such prongs. The collar 20-9 may include one or more keying features, here shown as two keying features 20-10 and 20-11 comprising protrusions that extend inwardly, although one or more keying features may alternatively or in addition be provided that extend outwardly. The keying features 20-10 and 20-11 on the first main connector 20-2 are configured to enable the first main connector 20-2 to electrically mate with connectors having complimentary keying features. Such connectors may be part of a cable (such as for example, the cable described in more detail below with reference to FIG. 10) or the second main connector on another module (such as, for example, module 22 in FIG. 1)

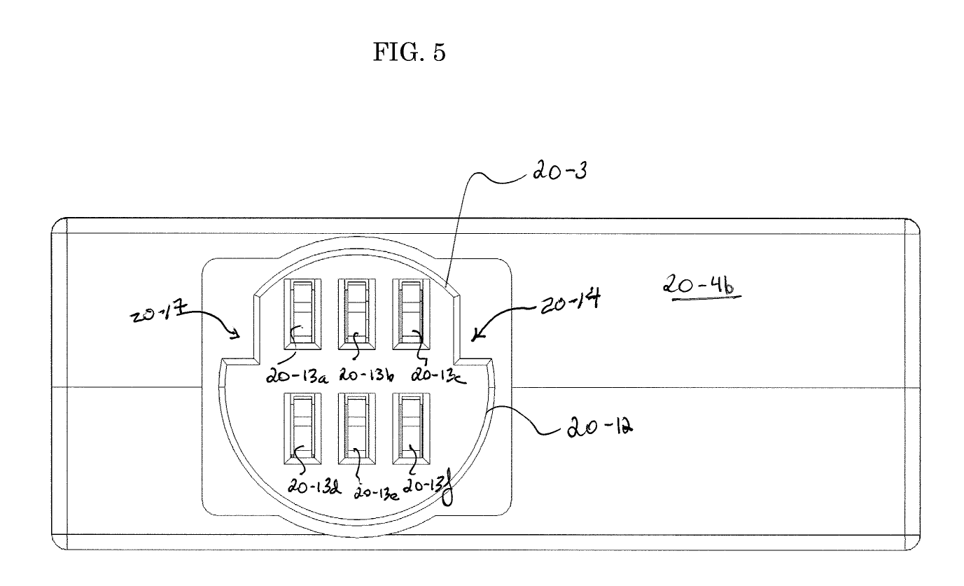

In an example implementation as shown in FIG. 5, the second main connector 20-3 comprises a generally cylindrical outwardly-extending plug 20-12 (shown also in FIG. 2). The module contacts in the second main connector 20-3 include a plurality of female contacts 20-13a through 20-13f also disposed in an array that matches or is complementary to the arrangement of male contacts 20-8 in the first main connector 20-2. The plug 20-12 may include keying features 20-14 and 20-17 to enable electrical mating with a connector having complementary keying features. Such a connector may be a part of a cable (such as for example the cable described with reference to FIG. 10) or the first main connector of another module (such as for example, module 22 in FIG. 1). In the example shown in FIG. 5, the generally circular cylindrical shape of the plug 20-12 and keying features 20-14 and 20-17 formed as inwardly-directed notches together define an outer plug shape that matches the inner shape of the collar 20-9 and the keying features 20-10 and 20-11 of the first main connector 20-2.

In the illustrated example implementation as shown in FIGS. 4, 5 and 10, either of the first and second main connectors 20-2 or 20-3 can be connected to one of the second and first connectors, respectively, of another module, such as the module 22 (in FIG. 1), or by a cable 40 (shown in FIG. 10). The cable 40 has first and second female and male ends or connectors 42, 44, respectively, identical to the main connectors 20-3 and 20-2. The cable 40 may include the at least one conductor 24, and more particularly may include up to the number of prongs 20-8 and sockets 20-13 of the module 20-2. The conductor(s) 24 are electrically connected to cable socket contacts 66 and cable prong contacts 67 of the female and male ends 42, 44 of the cable 40 in the manner noted hereinafter relative to the connections to the prongs 20-8 and the sockets 20-13.

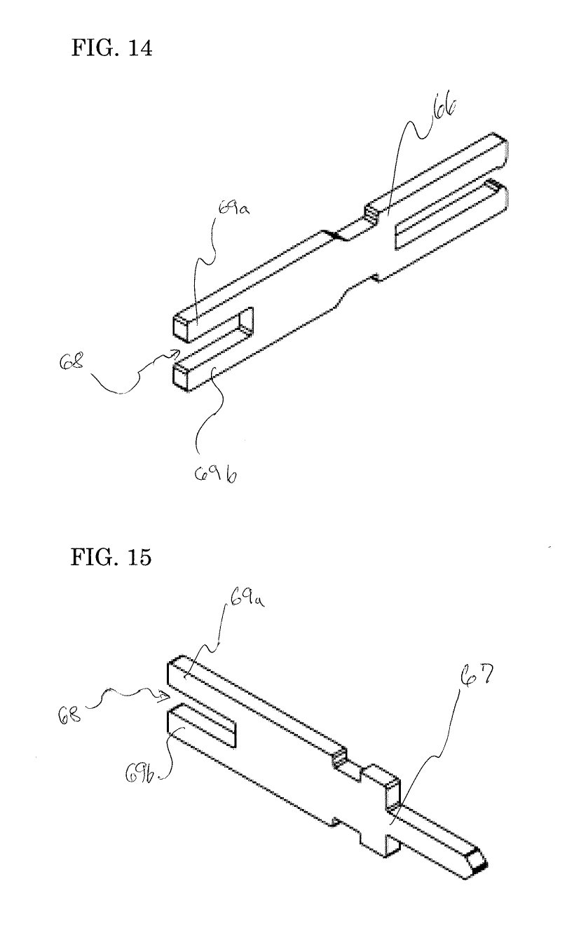

The illustrations depict example individual stamped cable socket contacts 66 (FIG. 14) and cable prong contacts 67 (FIG. 15) for utilization in the respective female and male ends 42, 44 of the cable 40. An interior end of the cable socket contact(s) 66 and/or the cable prong contact(s) 67 forms a tuning fork-shape with a space 68 disposed between two contact arms 69a, 69b. At least one of the conductor(s) 24, such as a wire, may be placed in the space 68 and soldered in place during assembly of the cable 40. The two contact arms 69a, 69b may provide support for the conductor during the soldering process and thereafter. Alternatively, in an example embodiment, the cable socket contacts 66 and cable prong contacts 67 are coupled with the conductor(s) 24 by ultra-sonic welding. When ultra-sonic welding is utilized, the two contact arms 69a, 69b are omitted from the interior end of the cable socket contacts 66 and cable prong contacts 67. Accordingly, the conductor(s) 24 are applied directly to the cable socket contacts 66 and/or cable prong contacts 67 such that locally applied ultra-sonic acoustic vibrations may be applied thereto for producing a welded connection. Ultra-sonic welding embodiments allow for the omission of solder and/or other connective materials/components thereby providing improved electrical conductivity and efficiency of assembly. In the illustrated embodiment, inasmuch as there are six male contacts 20-8 and six female contacts 20-13, the cable 40 may include up to six conductors that can interconnect the prongs and sockets of the main connectors of separate modules.

Of course, a cable 40 is not required inasmuch as the standardized male and female connectors can be directly connected together, if increased power distribution capacity is required or desirable.

The use of standardized male and female connectors standardizes interconnection of the various elements of the power distribution system and reduces the required part count and inventory for an installer to keep on hand. Specifically, the installer need only maintain stocks of modules and various lengths of cables (preferably only standardized lengths thereof).

Referring next to FIGS. 4, 7A, 7B, 7E, and 11, the prongs 20-8a through 20-8f comprise first end portions of male contacts 20-15a through 20-15f, respectively. Second end portions of the male contacts 20-15a through 20-15f are electrically connected in any suitable fashion, such as solder, to traces of a printed circuit board (PCB) 46.

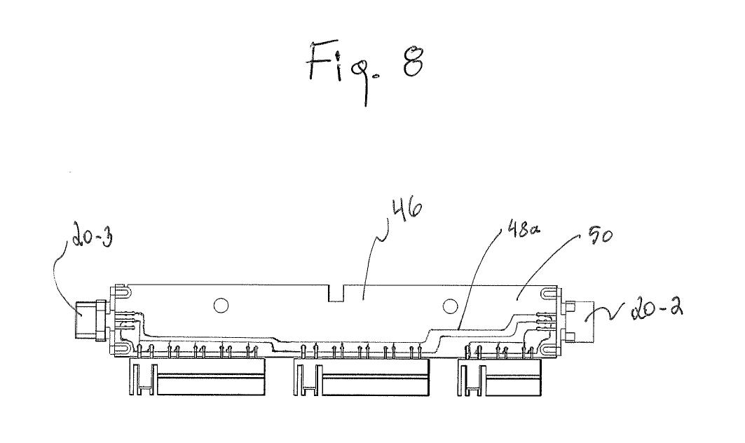

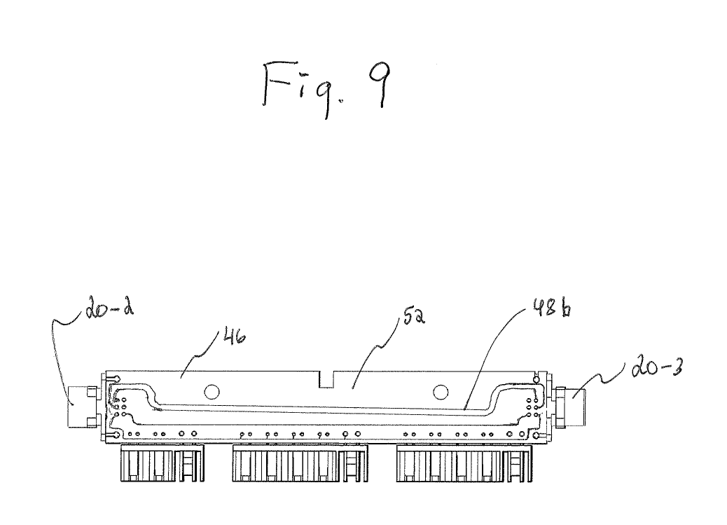

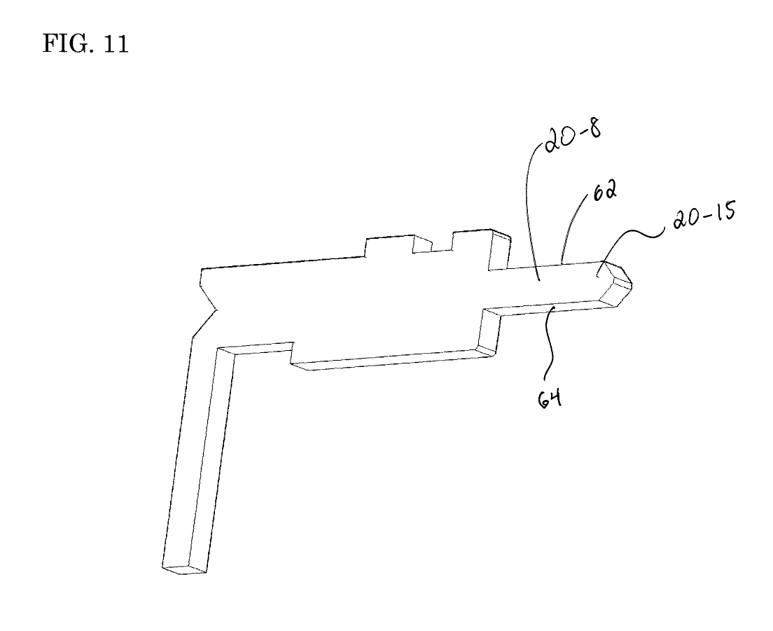

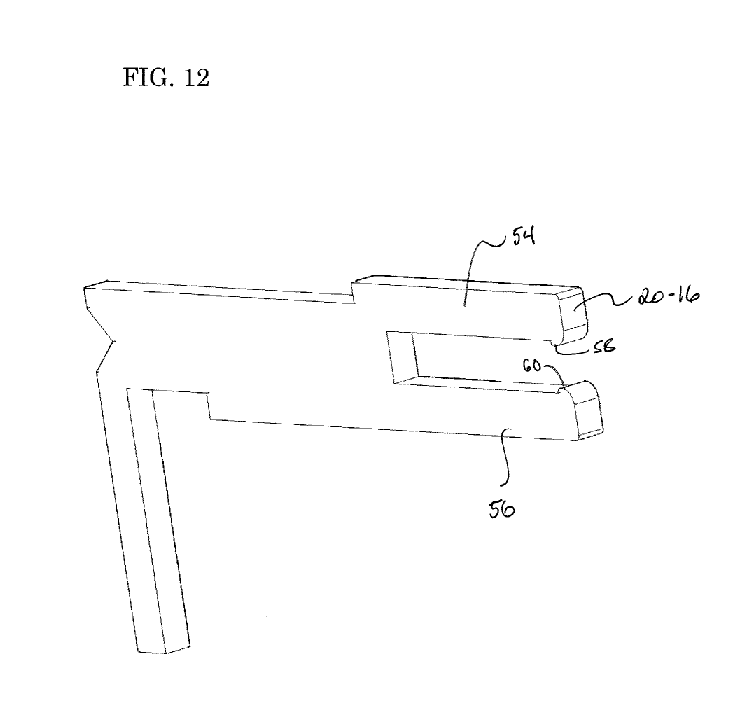

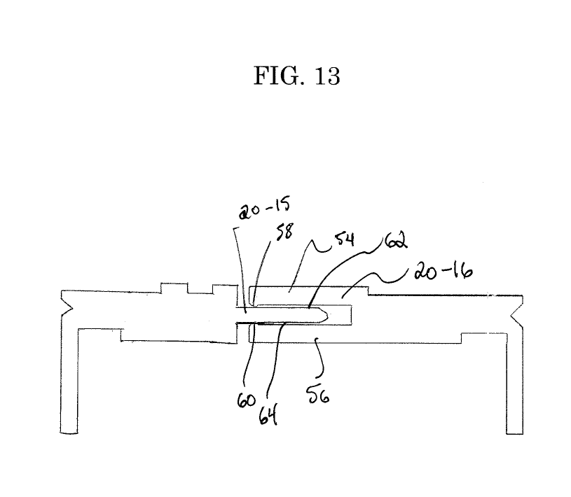

In like fashion, as seen in FIGS. 5, 7A, 7B, 7E and 12, disposed in the sockets 20-13a through 20-13f are first ends of female contacts 20-16a through 20-16f, respectively. Second end portions of the female contacts 20-16a through 20-16f are electrically connected in any suitable fashion, such as solder, to the traces of the PCB 46. The PCB has printed traces 48a, 48b disposed on opposing sides 50, 52, respectively, (FIGS. 8 and 9) that are connected together as appropriate by vias or through holes that are coated with solder. The traces interconnect each male contact 20-15a through 20-15f to a female contact 20-16a through 20-16f, respectively. Alternative arrangements of the printed traces, other than the arrangement of traces shown in FIGS. 8 and 9, may be utilized with the embodiments described herein, as desired, to meet design requirements for specific applications. The male contacts 20-15 and the female contacts 20-16 are retained in any suitable manner in the first and second main ports 20-2 and 20-3 and are stamped from an appropriate gauge of material. The material may be any metal or a conductive alloy. Examples of such metals or conductive alloys include, brass, copper, aluminum, or any other suitable metal or alloy that may be used to minimize resistance. The thickness and width of the traces 48a, 48b is likewise selected to minimize resistance. As seen in FIGS. 11-13, each male contact 20-15 fits edgewise into spaced bifurcated arms 54, 56 of a respective female contact 20-16 such that inwardly-facing barbs 58, 60 carried by the arms 54, 56, respectively are forced into intimate contact with opposed edges 62, 64 of the respective male contact 20-15. Low resistance electrical contact is thereby achieved.

If desired, the PCB 46 can be replaced by any other suitable interconnection member or members, such as discrete wires, or a combination of wires and one or more PCBs.

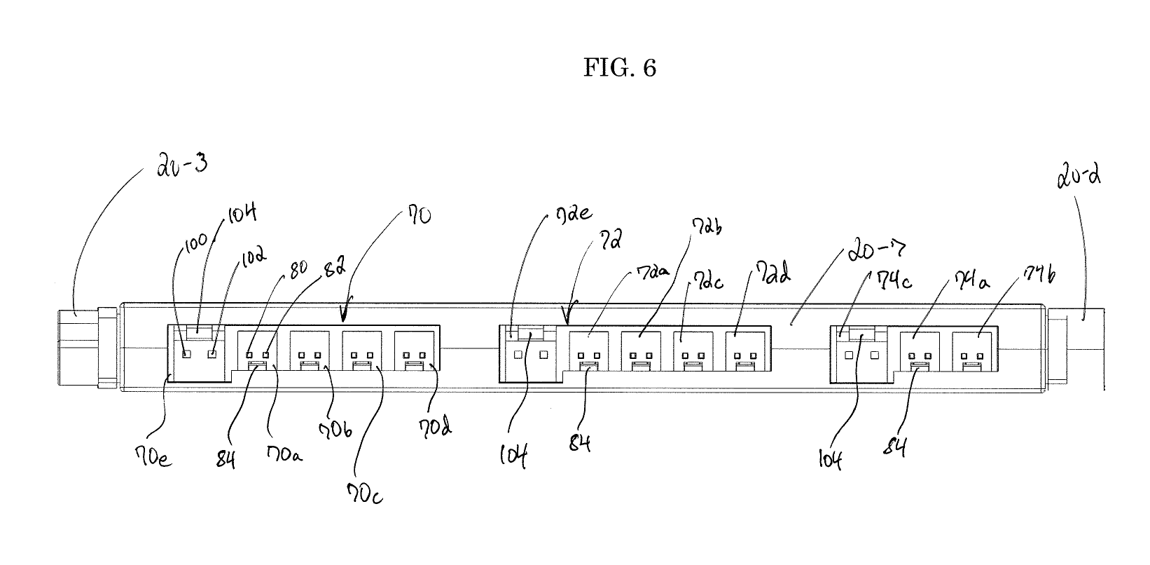

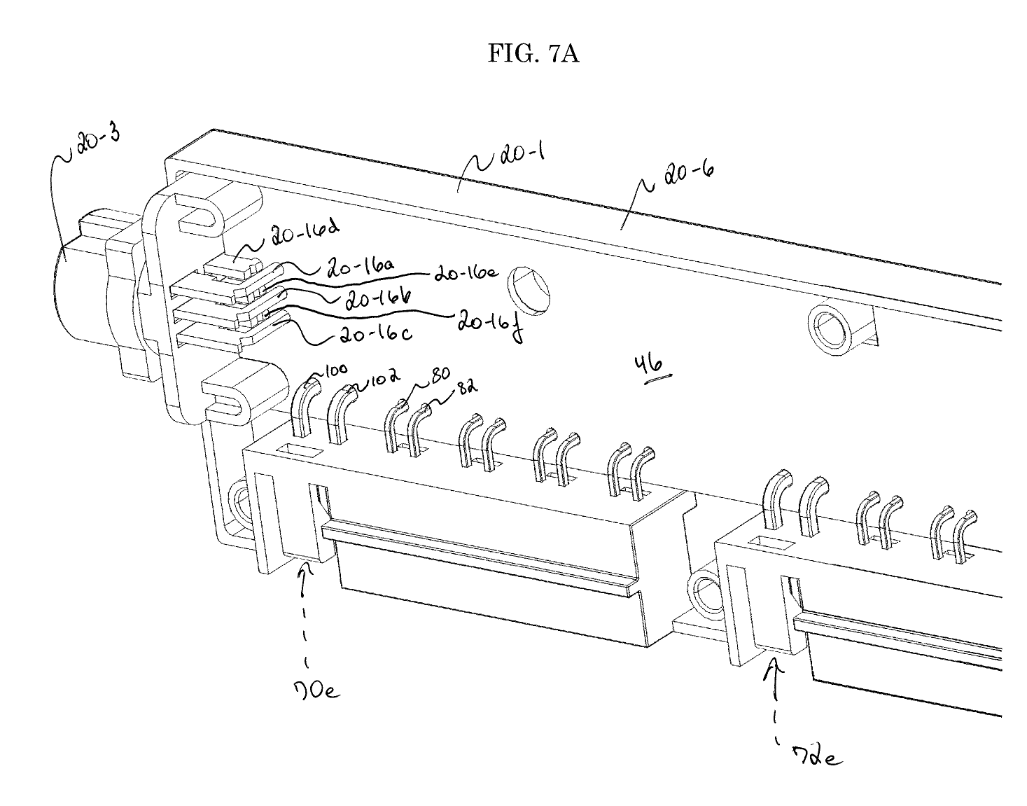

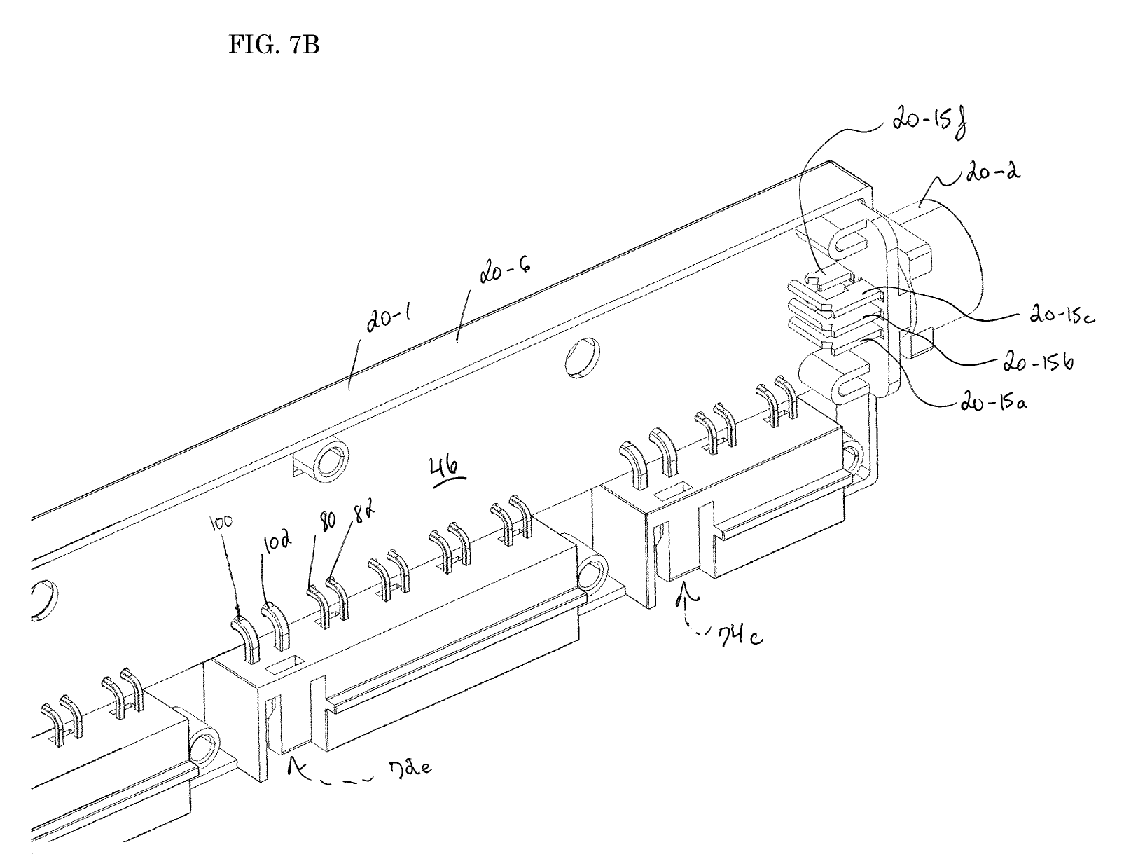

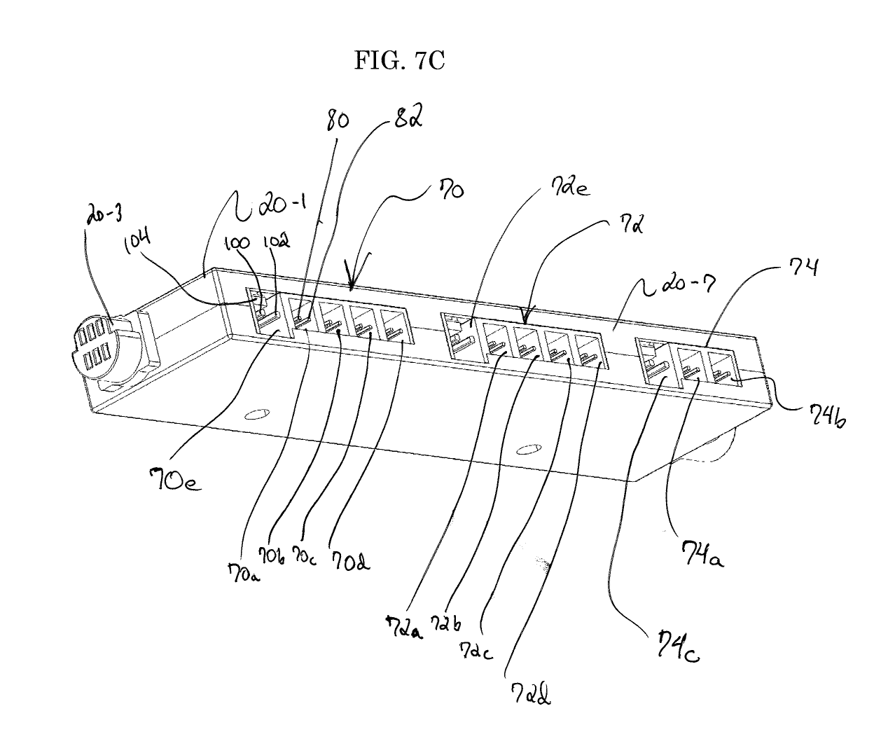

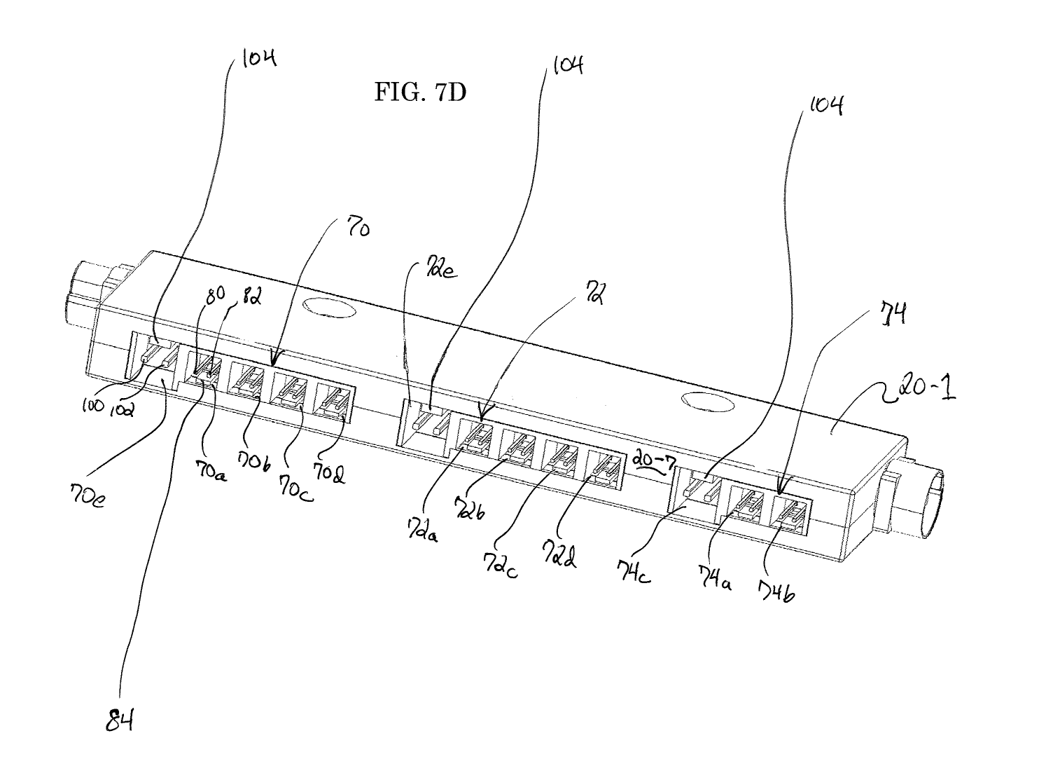

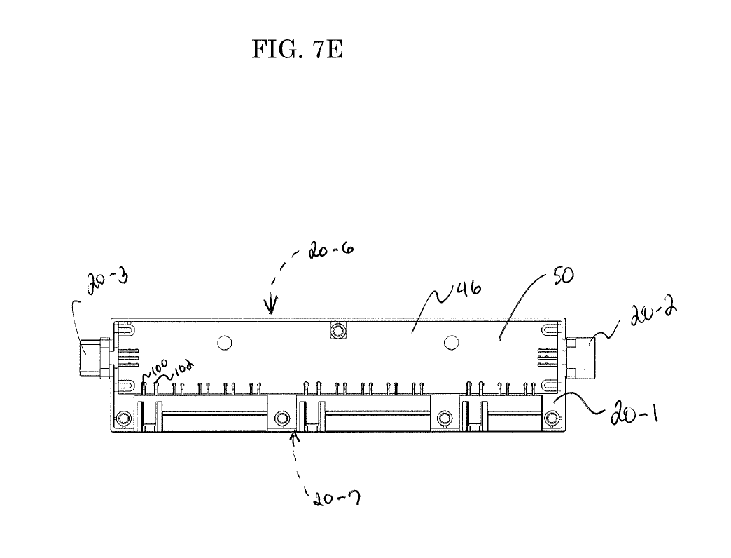

Referring next to FIGS. 6, 7C, and 7D, the bottom side 20-7 of the housing 20-1 further includes at least one output port. Specifically, in the illustrated embodiment, the housing includes three sets of output ports 70, 72, and 74. Each of the sets of output ports 70 and 72 comprise four output ports 70a-70d and 72a-72d, respectively, whereas the set of output ports 74 comprises two output ports 74a and 74b. Each output port 70, 72, 74, for example the output port 72a, includes two connection pins 80, 82 disposed adjacent a support platform 84. Each output port 70, 72, 74 is shaped to receive a suitable mating connector having female receptacles adapted to receive the connection pins 80, 82. The female receptacles of the mating connector 90 are coupled electrically to a load to be powered, such as an LED string.

The bottom side 20-7 of the housing 20-1 may further include one or more input ports, such as input ports 70e, 72e, and 74c. Each input port 70e, 72e, 74c, for example the input port 72e, includes two connection pins 100, 102 disposed adjacent a support platform 104. Each input port 70e, 72e, 74c is shaped to receive a suitable mating connector 110 having female receptacles adapted to receive the connection pins 100, 102. The female receptacles of the mating connector 110 are coupled electrically to a power source that supplies power, such as a driver circuit.

The connection pins of the ports 70a-70e, 72a-72e, and 74a-74c are electrically interconnected to the traces 48a, 48b to permit electrical interconnection between the main connectors 20-2 and 20-3 and the ports 70, 72, and 74. Specifically, power may be supplied through either of the main connectors 20-2 or 20-3 to the output ports 70a-70d, and/or to the output ports 72a-72d, and/or to the output ports 74a and/or 74b. Also, power may be transferred in either direction between the main connectors 20-2 and 20-3, or between either or both of the main connectors 20-2 and 20-3 and one or more of the input ports 70e, 72e, and/or 74c. Still further, power may be transferred from one or more of the input ports 70e, 72e, and/or 74c to one or more of the output ports 70a-70d, 72a-72d, and 74a and/or 74b.

### INDUSTRIAL APPLICABILITY

In summary, a power distribution module provides low resistance stamped contacts that are designed such that, in a specific embodiment, the contact makes electrical connection with a PCB via a standard solder through hole. The contact design utilizes a special stamped shape/geometry that employs a precise mechanical interference to establish two distinct points of contact at the barbs 58, 60 that generate a consistent amount of contact pressure that is tolerant of connector misalignment, thereby contributing to minimization of overall resistance of the power distribution system. The electrical contact points are made on the edges 62, 64 of the stamped contacts. The housing 20-1 provides electrical spacing sufficient for the application and also provides a touch-safe design based on UL 2238 requirements.

Also, to prevent a connector from being inserted incorrectly, the connector has keying features that interact with the mating connector such that the connector can only be plugged in one way. This makes it impossible for installers to mis-wire the system.

In addition, the contact design will incorporate a wire termination section that will accommodate ultra-sonic welding for further, least-resistance type of wire termination(s).

Furthermore, this disclosure contemplates embodiments having alternative loads other than groups or strings of LEDs. The electric power distribution system and the electric power distribution module(s) 20, 22 may provide power to can openers, mobile device chargers, audio equipment, fans, other kitchen appliances, other low voltage applications, or any combination of the aforementioned loads.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. An electrical power distribution module comprising:
a housing enclosing an interconnection member;
a first main connector formed in the housing having a first plurality of module contacts;
a second main connector formed in the housing having a second plurality of module contacts, wherein the first main connector and the second main connector are configured to connect to electrical conductors to receive an electrical current from a power source;
a plurality of conductive paths on the interconnection member, where at least two conductive paths are electrically connected with at least two of the first plurality of module contacts and to at least two of the second plurality of module contacts; and
at least one output port formed in the housing, the at least one output port comprising a pair of output port contacts electrically connected to the at least two conductive paths connected to module contacts in the first main connector and the second main connector.

2. The electrical power distribution module of claim 1, further comprising:
at least one input port comprising at least a pair of contacts each in electrical connection with a corresponding pair of conductive paths, the at least one input port configured to receive a secondary connector in electrical connection with the power source.

3. The electrical power distribution module of claim 1, where:
the first main connector and the second main connector are configured to receive a cable connector comprising at least two cable contacts disposed in the cable connector to electrically connect to the at least two of the first plurality of module contacts or second plurality of module contacts connected to the at least two conductive paths, and where the at least two cable contacts are connected to electrical conductors extending to supply electric current from the power source for a load connected to the at least one output port.

4. The electrical power distribution module of claim 3, where:
the first main connector is configured to receive a first cable connector comprising a plurality of cable socket contacts arranged in a first array;
the second main connector is configured to receive a second cable connector comprising a plurality of cable prong contacts arranged in a second array;
the first plurality of module contacts in the first main connector comprises a plurality of male contacts disposed in the first array; and
the second plurality of module contacts in the second main connector comprises a plurality of female contacts disposed in the second array.

5. The electrical power distribution module of claim 3, where:
the first main connector comprises a first keying feature to receive a first cable connector having a first complementary keying feature;
the second main connector comprises a second keying feature to receive a second cable connector having a second complementary keying feature.

6. The electrical power distribution module of claim 5, where:
the first keying feature comprises a collar and one or more protrusions extending inwardly to receive the first complementary form of the first cable connector comprising a generally cylindrical shape formed to fit within the collar of the first keying feature and notches formed to match the protrusions in the collar of the first main connector.

7. The electrical power distribution module of claim 5, where:
the second keying feature comprises a generally cylindrical shape having notches formed in the generally cylindrical shape to receive the second complementary keying feature comprising a collar on the second cable connector and one or more protrusions in the collar to match the notches in the second keying feature.

8. The electrical power distribution module of claim 4 where:
each of the female contacts comprise spaced bifurcated arms extending to a portion configured to extend to one of the conductive paths on the interconnection member; and
each of the male contacts is configured to fit edgewise into the spaced bifurcated arms of each of the female contacts forming a low resistance contact between inner edges of the bifurcated arms and lengthwise edges of the male contact.

9. The electrical power distribution module of claim 8 where each bifurcated arm on the female contacts includes an inward barb to provide additional low resistance contacts to the edges of the male contact.

10. The electrical power distribution module of claim 1 where the interconnection module is a printed circuit board and the plurality of conductive paths comprise a plurality of metal traces disposed on the printed circuit board.

11. The electrical power distribution module of claim 10 where at least some of the pairs of the plurality of conductive paths extend between through-holes, where at least some of the module contacts in the first main connector and the second main connector extend into corresponding through-holes and are affixed thereto by solder.

12. The electrical power distribution module of claim 4 where:
the first array and the second array are complementary so the male contacts in the first main connector align with the female contacts in the second main connector;
the first main connector comprises a form substantially configured to receive the second main connector to enable a direct connection of a first electrical power distribution module to a second electrical distribution module without using a cable.

13. A system for distributing electrical power comprising:
a driver circuit configured to provide a DC power;
a first electric power distribution module comprising a first main connector in electrical connection with a second main connector via a plurality of conductive paths between at least a pair of module contacts on the first main connector and at least a pair of module contacts on the second main connector;
where the first main connector and the second main connector are configured to connect electrically to either the driver circuit to receive DC power or to a second electric power distribution module; and
at least one output port on the first electric power distribution module in electrical connection with one of the at least one pair of conductive paths between the first main connector and the second main connector to provide power to a load in electrical connection with the at least one output port.

14. The system for distributing electrical power of claim 13 where:
the first electric power distribution module further comprises at least one input port configured to receive DC power, where the input port is in electrical connection with one of the at least one pair of conductive paths to provide power to the at least one pair of conductive paths.

15. The system for distributing electrical power of claim 13 where the driver circuit is configured to convert an AC power signal to the DC power signal.

16. The system for distributing electrical power of claim 13 where the second electrical distribution module comprises substantially the same structure as the first electrical distribution module, the second electrical distribution module comprising:
a first main connector on the second electrical distribution module;
a second main connector on the second electrical distribution module;
at least a pair of conductive paths connecting the first main connector and the second main connector on the second electrical distribution module; and
at least one output port on the second electrical distribution module in electrical connection with one of the at least one pair of conductive paths, the at least one output port configured to connect electrically to a load for the second electrical distribution module.

17. The system for distributing electrical power of claim 16 further comprising:
a cable comprising a first cable connector configured to mate in electrical connection with the second main connector of the first electrical distribution module and a second cable connector configured to mate in electrical connection with the first main connector of the second electrical distribution module.

18. The system for distributing electrical power in claim 17 where:
the plurality of conductive paths between the first main connector and the second main connector in the first electrical distribution module includes two pairs of conductive paths;
the plurality of conductive paths between the first main connector and the second main connector in the second electrical distribution module includes two pairs of conductive paths;
the two pairs of conductive paths in the first electrical distribution module and the second electrical distribution module connect to corresponding conductors in the cable;
the at least one output port on the first electrical distribution module is in electrical connection with a first of the two pairs of conductive paths in the first electrical distribution module;
the at least one output port on the second electrical distribution module is in electrical connection with a first of the two pairs of conductive paths in the second electrical distribution module.

19. The system for distributing electrical power of claim 16 where:
the first main connector of the first electrical distribution module and the second electrical distribution module comprises a first keying feature; and
the second main connector of the first electrical distribution module and the second electrical distribution module comprises a second keying feature complementary with the first keying feature to permit mating in electrical connection with the first main connector; where the second main connector of the first electrical distribution module is configured to mate in electrical connection with the first main connector of the second electrical distribution module.

20. The system for distributing electrical power of claim 19 further comprising:
a cable having a first cable connector comprising the second keying feature complementary with the first keying feature to permit mating in electrical connection with the second main connector of the first electrical distribution module, and a second cable connector comprising the first keying feature to permit mating in electrical connection with the first main connector of the second electrical distribution module.
